(19) United States
(12) Patent Application Publication
(10) Pub. No.: US 2021/0024804 A1
(43) Pub. Date: Jan. 28, 2021

(54) THERMALLY CONDUCTIVE SILICONE RUBBER COMPOSITION, SHEET THEREOF, AND METHOD FOR PRODUCING SAME

(71) Applicant: Fuji Polymer Industries Co., Ltd., Nagoya-shi (JP)

(72) Inventor: Toshiki OGAWA, Aichi (JP)

(21) Appl. No.: 17/070,535

(22) Filed: Oct. 14, 2020

Related U.S. Application Data
(63) Continuation of application No. PCT/JP2019/036279, filed on Sep. 17, 2019.

(30) Foreign Application Priority Data
Dec. 21, 2018 (JP) 2018-239685

(51) Int. Cl. C09K 5/14; C09D 183/04; C09D 5/00; C09D 7/61; C09D 7/40; D06N 3/00; D06N 3/12

(52) U.S. Cl. CPC C09K 5/14; C09D 183/04; C09D 5/00; C09D 7/61; C09D 7/69; D06N 2209/062; D06N 3/0022; D06N 3/128; D06N 3/0063; D06N 3/0077; D06N 3/0088; C09D 7/68

(57) ABSTRACT

A thermally conductive silicone composition includes silicone as a matrix component and a thermally conductive filler. The matrix component includes a silicone base polymer having a vinyl group and a silicone oil having no vinyl group. The thermally conductive filler includes aluminum nitride particles. The thermally conductive silicone composition includes a peroxide as a curing component. A thermally conductive silicone sheet 1 of the present invention includes the thermally conductive silicone composition (3,4) being applied to at least one surface of a sizing sheet of a glass cloth 2. The thickness of the thermally conductive silicone sheet is 0.1 to 1 mm. Thus, a thermally conductive silicone rubber composition that is flexible and has strength and high thermal conductive properties, a sheet thereof, and a method for producing the sheet are provided.

### TECHNICAL FIELD

The present invention relates to a thermally conductive silicone rubber composition, a sheet thereof, and a method for producing the sheet.

### BACKGROUND ART

Semiconductors used in computers (CPUs), transistors, light-emitting diodes (LEDs), etc. generate heat during operation, and the performance of electronic components may be reduced by the heat. To cope with this, heat dissipaters are attached to the electronic components that generate heat. The heat dissipaters are often made of metal. Therefore, the adhesion of a heat dissipating part to a CPU is enhanced by inserting a sheet-like or gel-like thermally conductive composition between them. In order to improve the thermal conductivity of a heat-dissipating material, which is the final purpose, the thermally conductive composition needs to contain a large amount of thermally conductive inorganic powder. However, merely increasing the amount of thermally conductive inorganic powder results in various problems. For example, when the heat-dissipating material is in the form of an elastomer, the hardness is too high, so that an electronic component and a heat dissipater cannot be spaced at a predetermined small distance from each other. Moreover, the space between the electronic component and the heat dissipater cannot be filled with the heat-dissipating material as desired. In the case of an elastomeric or gel-like heat-dissipating material, the compression set is increased and long-term reliability is likely to be deteriorated. Further, there is also a problem that the hardness may be increased by a high temperature thermal history.

To solve these problems, various approaches have been proposed conventionally. The present applicant proposes in Patent Document 1 that small particles of alumina are surface treated with an alkylsilane compound. It is proposed to use 0.1 to 5 μm of amorphous alumina and 5 to 50 μm of spherical alumina (Patent Document 2). Patent Document 3 proposes a thermally conductive sheet using a glass cloth.

### PRIOR ART DOCUMENTS

### Patent Documents

Patent Document 1: JPWO 2009/136542 A1

Patent Document 2: JP 1102-041362 A

Patent Document 3: JP 2015-233104 A

### DISCLOSURE OF INVENTION

### Problem to be Solved by the Invention

However, thermally conductive silicone rubbers in the conventional technologies have problems of high thermal resistance values.

To solve the above conventional problems, the present invention provides a thermally conductive silicone rubber composition having a low thermal resistance value, a sheet thereof, and a method for producing the sheet.

### Means for Solving Problem

A thermally conductive silicone composition of the present invention includes silicone as a matrix component and a thermally conductive filler. The matrix component includes a silicone base polymer having a vinyl group and a silicone oil having no vinyl group. The thermally conductive filler includes aluminum nitride particles. The thermally conductive silicone composition includes a peroxide as a curing component.

A thermally conductive silicone sheet of the present invention includes the thermally conductive silicone composition that is applied to at least one surface of a sizing sheet of a glass cloth. A thickness of the thermally conductive silicone sheet is 0.1 to 1 mm.

A method for producing the thermally conductive silicone sheet of the present invention includes adding a diluent to the thermally conductive silicone composition to prepare a coating liquid; impregnating a glass cloth with the coating liquid, drying the glass cloth, and then heating and curing the glass cloth to prepare a sizing sheet; and coating at least one surface of the sizing sheet of the glass cloth with the coating liquid, drying the sizing sheet, and then heating and curing the sizing sheet.

### Effects of the Invention

In the present invention, the matrix component includes a silicone base polymer having a vinyl group and a silicone oil having no vinyl group. The thermally conductive filler includes aluminum nitride particles. The thermally conductive silicone composition includes a peroxide as a curing component. Thus, the present invention can provide a thermally conductive silicone rubber composition having a low thermal resistance value, a sheet thereof, and a method for producing the sheet.

### BRIEF DESCRIPTION OF DRAWINGS

FIG. 1 is a schematic cross-sectional view of a thermally conductive silicone sheet in one embodiment according to the present invention.

FIG. 2A is a schematic plan view illustrating a method for measuring a thermal resistance value, and FIG. 2B is a schematic cross-sectional view taken along the line I-I.

### DESCRIPTION OF THE INVENTION

In the present invention, it is preferable not to use a platinum-based catalyst for the following reasons.

(1) The composition of the present invention is dissolved in a solvent before coating, and the remaining material will be used for the next production in terms of cost. However, if the composition includes a platinum-based catalyst (addition reaction system), the life becomes shorter and the curing is more likely to proceed than if the composition includes a peroxide. Thus, it is difficult to use the material including the platinum-based catalyst for the next production.
(2) When the composition is cured using the platinum-based catalyst (addition reaction system), only a part having a vinyl group reacts, resulting in insufficient curing. When the composition is cured using the peroxide, a part having a vinyl group and a part having a methyl group react, and thus the curing sufficiently proceeds.

The present inventor studied that whether the addition of a silicone base polymer having a vinyl group and a silicone oil having no vinyl group could improve the thermal resistance value problem. Here, silicone gum exhibits properties intermediate between the silicone oil (fluid) and the silicone rubber (solid). In the present invention, the silicone base polymer having a vinyl group refers to silicone gum and oil that have a vinyl group.

The silicone base polymer having a vinyl group of the matrix component of the present invention is highly reactive, and has a high strength in comparison with that having no vinyl group. The silicone oil having no vinyl group is less reactive, but has flexibility. Therefore, the silicone gum and oil that have a vinyl group and the silicone oil having no vinyl group can balance strength and flexibility.

To enhance the conduction of heat, alumina has been highly packed conventionally. However, if alumina is highly packed, the strength and the flexibility tend to decrease. Thus, aluminum nitride particles will be packed, which can enhance the conduction of heat and maintain good strength and flexibility.

In the present invention, curing proceeds due to the curing action by the radical reaction using a peroxide curing agent. The peroxide curing agent is preferably 0.01 to 10 parts by mass, and more preferably 0.1 to 8 parts by mass with respect to 100 parts by mass of the matrix component. Preferably, examples of the peroxide curing agent include the following: acyl peroxides such as benzoyl peroxide and bis(p-methylbenzoyl) peroxide; alkyl peroxides such as di-tert-butyl peroxide, 2,5-dimethyl-2,5-di(tert-butylperoxy)hexane, tert-butyl cumyl peroxide, and dicumyl peroxide; and ester-based organic peroxides such as tert-butyl perbenzoate.

If the matrix component is 100 parts by mass, the silicone base polymer having a vinyl group (silicone gum) is 44 to 71.

If the matrix component is 100 parts by mass, the silicone oil having no vinyl group is 11 to 45. Moreover, the composition of the present invention may include a both-terminal vinyl silicone oil. If the matrix component is 100 parts by mass, the both-terminal vinyl silicone oil is 11 to 45.

The oil having no vinyl group may be basically any dimethylsilicone oil, and includes e.g., phenylmethylsilicone oil and fluorosilicone oil.

It is preferable that the matrix component is a polysiloxane having at least two alkenyl groups bonded to silicon atoms per molecule. Examples of the alkenyl groups include vinyl, allyl, and propenyl groups. Examples of organic groups other than the alkenyl groups include the following: alkyl groups such as methyl, ethyl, propyl, butyl, pentyl, hexyl, octyl, decyl, and dodecyl groups; aryl groups such as phenyl and tolyl groups; aralkyl groups such as a β-phenylethyl group; and halogen-substituted alkyl groups such as 3,3,3-trifluoropropyl and 3-chloropropyl groups. Moreover, small amounts of hydroxyl groups may be present at the ends of a molecular chain or the like. The molecular structure of the polysiloxane may be a linear, a linear with branches, a ring, or a mesh-like structure. Two or more types of diorganopolysiloxanes may be used together. The molecular weight of the polysiloxane is not particularly limited. The polysiloxane may include liquid polysiloxanes having a low viscosity and gum-like polysiloxanes having a high viscosity. To produce a rubber-like elastic body as a result of curing, a viscosity of 100 mPa·s or more at 25° C. is preferred. Gum-like polysiloxanes having a polystyrene-equivalent number-average molecular weight of 200,000 to 700,000 measured by gel permeation chromatograph (GPC) are more preferred.

The amount of the thermally conductive filler added is preferably 600 to 2000 parts by mass, more preferably 700 to 1900 parts by mass, and further preferably 800 to 1800 parts by mass with respect to 100 parts by mass of the matrix component. Moreover, if the thermally conductive filler is 100 parts by mass, the aluminum nitride particles are preferably 10 to 100 parts by mass, more preferably 15 to 90 parts by mass, and further preferably 20 to 80 parts by mass.

It is preferable that the thermally conductive filler further includes alumina particles. If the thermally conductive filler is 100 parts by mass, the alumina particles are preferably 20 to 100 parts by mass, more preferably 25 to 90 parts by mass, and further preferably 30 to 80 parts by mass. It is preferable that the alumina particles include a mixture of particles (A) with an average particle size of 10 μm or more and 20 μm or less and particles (B) with an average particle size of 0.01 μm or more and less than 10 μm. It is preferable that the mixing ratio of A to B is 90:10 to 10:90 in mass ratio.

The average particle size of the thermally conductive filler is preferably 0.01 to 20 μm, and more preferably 0.1 to 15 μm. Thus, the thermally conductive filler can be favorably mixed with the matrix resin and have good processability. The average particle size means D50 (median diameter) in a volume-based cumulative particle size distribution, which is determined by a particle size distribution measurement with a laser diffraction scattering method. The measuring device may be, e.g., a laser diffraction/scattering particle size distribution analyzer LA-950 S2 manufactured by HORIBA, Ltd.

It is preferable that the thermally conductive silicone composition does not include reinforcing silica. If reinforcing silica is included, it is disadvantageous in that the hardness increases, and thus contact thermal resistance increases.

The composition of the present invention may include components other than the above as needed. For example, the composition may include an inorganic pigment such as colcothar, and alkyltrialkoxysilane used, e.g., for the surface treatment of a filler, a flow control agent, a tackifier, and a flame retardant. Moreover, alkoxy group-containing silicone may be added, e.g., for the surface treatment of a filler.

A thermally conductive silicone sheet of the present invention includes the thermally conductive silicone composition that is applied to at least one surface of a sizing sheet of a glass cloth. It is preferable that both surfaces of the sizing sheet are coated. The thickness of the thermally conductive silicone sheet is 0.1 to 1 mm. If the thickness is less than 0.1 mm, the production is difficult. If the thickness is more than 1 mm, the coating is difficult. It is preferable that the glass cloth has a mass of 25 to 54 g/m² and is a woven fabric having a plain weave texture in which a warp density and a weft density are each 56 to 60 threads/25 mm.

The thermal conductivity of a bulk in one example of the thermally conductive silicone sheet of the present invention is preferably 1 W/m·k or more, and more preferably 3.3 W/m·k or more. Here, the term “bulk” refers to the state of the composition that includes, e.g., the silicone base polymer, the filler, and other additive agents before it is dissolved in the solvent.

In a method for producing the thermally conductive silicone sheet of the present invention, first, a diluent is added to the thermally conductive silicone composition to prepare a coating liquid. To prepare the coating liquid, the matrix resin component and the thermally conductive filler, and optionally a flame retardant and a pigment, are added and uniformly mixed to prepare a composition. Subsequently, a peroxide curing component and a diluent solvent are added to the composition. The diluent solvent may be added in an appropriate amount so that the coating can be performed. The viscosity for coating is preferably of 3,000 to 10,000 cps.

Next, the glass cloth is impregnated with the coating liquid, dried, heated and cured to prepare a sizing sheet. The sizing sheet is a sealed glass cloth sheet.

Next, at least one surface of the sizing sheet of the glass cloth is coated with the coating liquid, dried, and then heated and cured to obtain the thermally conductive silicone sheet. The coating is preferably knife coating because it can provide a thin coating. It is preferable that the curing is performed at a temperature of 150 to 180° C. for 3 to 10 minutes.

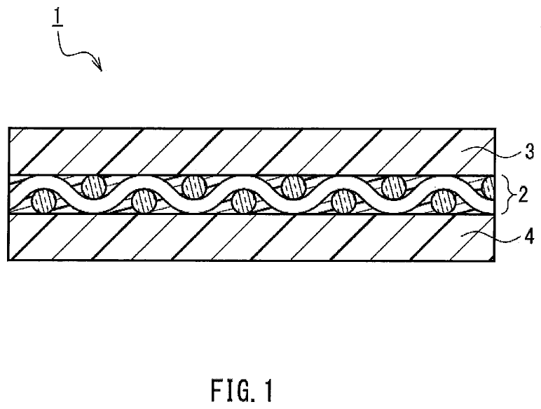

Hereinafter, the present invention will be described with reference to the drawings. FIG. 1 is a schematic cross-sectional view of a thermally conductive silicone sheet in one embodiment according to the present invention. A thermally conductive silicone sheet 1 is produced as follows. The glass cloth is impregnated with the coating liquid, dried, heated and cured to prepare a sizing sheet layer 2. Both surfaces of the layer are coated with the coating liquid containing the thermally conductive silicone composition, dried, and then heated and cured. Reference numerals 3 and 4 indicate a thermally conductive silicone coating layer.

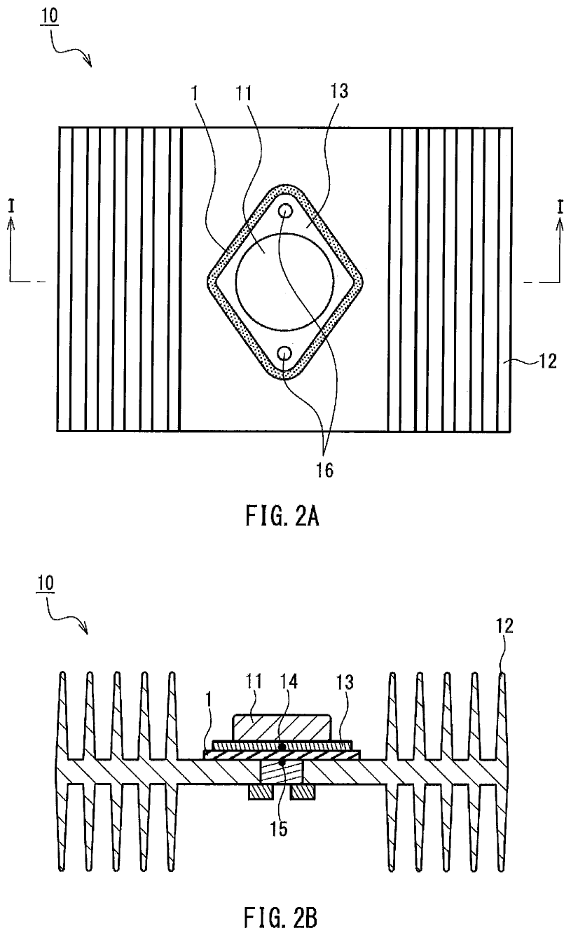

FIG. 2A is a schematic plan view illustrating a method for measuring a thermal resistance value, and FIG. 2B is a schematic cross-sectional view taken along the line I-I. The thermal resistance measuring method is a method according to ASTM D5470, and the thermal resistance value of the thermally conductive silicone sheet 1 is measured using a thermal resistance measurement apparatus 10. The thermally conductive silicone sheet 1 cut into a rhomboid (TO-3 type) is sandwiched between a transistor 11 and a heat sink 12, and screwed at a predetermined torque. A constant power is applied to the transistor 11 so that heat is generated. The thermal resistance value is determined from the difference in the temperature between the transistor 11 and the heat sink 12. Reference numeral 13 indicates a pressing plate. Reference numeral 14 indicates a temperature sensor for the transistor. Reference numeral 15 indicates a temperature sensor for the heat sink. Reference numeral 16 indicates an M3 screw. In one example, the torque is 3 kg·cm (0.29 Nm), 5 kg·cm (0.49 Nm), or 7 kg·cm (0.69 Nm).

### EXAMPLES

Hereinafter, the present invention will be described by way of examples. However, the present invention is not limited to the following examples.

<Method for Measuring Thermal Resistance Value>

The measurement was performed using the apparatus illustrated in FIGS. 2A and 2B.

The thermal resistance value was calculated by the following formula:

Rt=(Tc−Tf)/P₀,

where Rt represents a thermal resistance value (K·cm²/W);
Tc represents a transistor temperature (° C.);
Tf represents a heat sink temperature (° C.); and
P₀ represents a constant power (W).

The measurement apparatuses included the following:

a transistor 2SC2245 (TO-3 type); and
a heat sink 40CH104L-90-K.

### Example 1

(1) Raw Materials

(A) Matrix component

(A-1) Silicone gum having a vinyl group: gum having a vinyl group at both ends and a side chain, 80 g (manufactured by Elkem Japan K.K.)

(A-2) Both-terminal vinyl silicone oil having a viscosity of 350 mm²/s at a temperature of 25° C. (manufactured by Elkem Japan K.K.)

(A-3) Silicone oil having no vinyl group having a viscosity of 300 cs at a temperature of 25° C. (manufactured by Dow Corning Toray Co., Ltd.)

(B) Thermally conductive filler

(B-1) Aluminum nitride having an average particle size of 10 μm (manufactured by TOYO ALUMINIUM K.K).

(B-2) Alumina having an average particle size of 12 μm (manufactured by Nippon Light Metal Co., Ltd.)

(B-3) Alumina having an average particle size of 2 μm (manufactured by Showa Denko K.K.)

(B-4) Alumina having an average particle size of 0.3 μm (manufactured by Sumitomo Chemical Co., Ltd.)

(C) Pigment: “Brown 105A” manufactured by Wacker Asahikasei Silicone Co., Ltd.

(D) Peroxide curing component: Bis(4-methyl)benzoyl peroxide

The above raw materials were uniformly kneaded using a kneader to prepare a thermally conductive silicone composition.

(2) Coating Liquid 1

A coating liquid 1 was prepared by adding 3 g of a 50% paste liquid of bis(4-methyl)benzoyl peroxide as a peroxide curing component and an appropriate amount of solvent xylene as a diluent to 100 g of the above raw material composition.

(3) Coating Liquid 2

A coating liquid 2 was prepared by adding 0.8 g of a 50% paste liquid of bis(4-methyl)benzoyl peroxide as a peroxide curing component and an appropriate amount of solvent xylene as a diluent to 100 g of the above raw material composition.

(4) Coating

First, a glass cloth having a thickness of about 35 μm (a mass of 25 g/m², a woven fabric having a plain weave texture in which a warp density and a weft density are each 56 threads/25 mm) was impregnated with the coating liquid 1, dried, heated and cured to prepare a sizing sheet.

Next, one surface of the sizing sheet was coated with the coating liquid 2 using a knife coater, dried, placed in a heater, and heated and cured at 180° C. for three minutes. Next, the other surface of the sizing sheet was coated with the coating liquid 2 using the knife coater, and dried. Then, the sizing sheet was placed in the heater, and heated and cured at 180° C. for three minutes. Thus, a thermally conductive silicone sheet having a total thickness of 0.2 mm and a thermally conductive silicone sheet having a total thickness of 0.33 mm were produced.

### Comparative Examples 1-3

Comparative examples were performed as in Example 1 except that the above silicone oil (A-3) having no vinyl group was not added. Table 1 shows the addition amount of each of the components. Table 2 shows the thermal resistance values.

TABLE 1

| | | | | | Comp. | Comp. | Comp. |
|---|---|---|---|---|---|---|---|
| | | Ex. 1 | Ex. 2 | Ex. 3 | Ex. 1 | Ex. 2 | Ex. 3 |
| Matrix | A-1 (g) | 80 | 50 | 50 | 80 | 80 | 80 |
| component | A-2 (g) | 20 | 50 | 13.5 | 20 | 20 | 20 |
| (A) | A-3 (g) | 13.5 | 13.5 | 50 | 0 | 0 | 0 |
| | Total (g) | 113.5 | 113.5 | 113.5 | 100 | 100 | 100 |
| Thermally | B-1 (g) | 300 | 300 | 300 | 264 | 300 | 0 |
| conductive | B-2 (g) | 80 | 80 | 80 | 70 | 80 | 380 |
| filler | B-3 (g) | 325 | 325 | 325 | 286 | 325 | 325 |
| (B) | B-4 (g) | 195 | 195 | 195 | 172 | 195 | 195 |
| | Total (g) | 900 | 900 | 900 | 792 | 900 | 900 |

| | | | | | | |
|---|---|---|---|---|---|---|
| Parts by mass of | 793 | 793 | 793 | 792 | 900 | 900 |
| component (B) with | | | | | | |
| respect to 100 parts by | | | | | | |
| mass of component (A) | | | | | | |
| Pigment (g) | 2 | 2 | 2 | 2 | 1.5 | 2 |
| Peroxide curing | 8 | 8 | 8 | 8 | 8 | 8 |
| component (g) | | | | | | |

*Ex.: Example, Comp. Ex.: Comparative Example

TABLE 2

| | | | Thermal resistance value (K · cm²/W) | | | | | |
|---|---|---|---|---|---|---|---|---|
| | | Tightening | | | | Comp. | Comp. | Comp. |
| Thickness | | torque | Ex. 1 | Ex. 2 | Ex. 3 | Ex. 1 | Ex. 2 | Ex. 3 |
| 0.2 | mm | 3 kgf · cm | 0.84 | — | — | 0.90 | 1.18 | — |
| | | 5 kgf · cm | 0.81 | 0.84 | 0.83 | — | 0.85 | 0.94 |
| | | 7 kgf · cm | 0.68 | — | — | — | 0.72 | — |
| 0.33 | mm | 3 kgf · cm | 1.66 | — | — | 2.13 | 2.19 | — |
| | | 5 kgf · cm | 1.50 | 1.47 | 1.52 | — | 1.77 | — |
| | | 7 kgf · cm | 1.34 | — | — | — | 1.57 | — |

*Ex.: Example, Comp. Ex.: Comparative Example

As apparent from Tables 1 and 2, the products of Examples of the present invention were able to obtain lower thermal resistance values than Comparative Examples 1-3.

### INDUSTRIAL APPLICABILITY

The thermally conductive silicone composition and the sheet of the present invention can be applied to heat dissipating members or the like interposed between a heat generating part and a heat sink of an electronic component.

### DESCRIPTION OF REFERENCE NUMERALS

1 thermally conductive silicone sheet
2 sizing sheet layer of glass cloth
3,4 thermally conductive silicone coating layer
10 thermal resistance measurement apparatus
11 transistor
12 heat sink
13 pressing plate
14 temperature sensor for transistor
15 temperature sensor for heat sink
16 M3 screw

1-12. (canceled)

13. A thermally conductive silicone composition, which is a thermally conductive silicone cured product, comprising:
a silicone polymer as a matrix component; and
a thermally conductive filler,
wherein the matrix component includes a silicone base polymer (A) having a vinyl group, a silicone oil (B) having no vinyl group, and a silicone oil (C) having vinyl groups at both terminals,
the silicone base polymer (A) having a vinyl group is silicone gum,
if the matrix component is 100 parts by mass, the silicone base polymer (A) having a vinyl group is 44 to 71 parts by mass, the silicone oil (B) having no vinyl group is 11 to 45 parts by mass, and the silicone oil (C) having vinyl groups at both terminals is 11 to 45 parts by mass,
the thermally conductive filler includes aluminum nitride particles, and
the thermally conductive silicone composition includes a peroxide as a curing component.

14. The thermally conductive silicone composition according to claim 13, wherein the thermally conductive filler is 600 to 2000 parts by mass with respect to 100 parts by mass of the matrix component.

15. The thermally conductive silicone composition according to claim 13, wherein if the thermally conductive filler is 100 parts by mass, the aluminum nitride particles are 10 to 100 parts by mass.

16. The thermally conductive silicone composition according to claim 13, wherein the thermally conductive filler further includes alumina particles.

17. The thermally conductive silicone composition according to claim 13, wherein an average particle size of the thermally conductive filler is 0.1 to 20 μm.

18. The thermally conductive silicone composition according to claim 13, wherein the thermally conductive silicone composition does not include reinforcing silica.

19. A thermally conductive silicone sheet comprising a thermally conductive silicone composition, the thermally conductive silicone composition being applied to at least one surface of a sizing sheet of a glass cloth,
the thermally conductive silicone composition, which is a thermally conductive silicone cured product, comprising:
a silicone polymer as a matrix component; and
a thermally conductive filler,
wherein the matrix component includes a silicone base polymer (A) having a vinyl group, a silicone oil (B) having no vinyl group, and a silicone oil (C) having vinyl groups at both terminals,
the silicone base polymer (A) having a vinyl group is silicone gum,
if the matrix component is 100 parts by mass, the silicone base polymer (A) having a vinyl group is 44 to 71 parts by mass, the silicone oil (B) having no vinyl group is 11 to 45 parts by mass, and the silicone oil (C) having vinyl groups at both terminals is 11 to 45 parts by mass,
the thermally conductive filler includes aluminum nitride particles, and
the thermally conductive silicone composition includes a peroxide as a curing component,
wherein a thickness of the thermally conductive silicone sheet is 0.1 to 1 mm.

20. The thermally conductive silicone sheet according to claim 19, wherein both surfaces of the sizing sheet of the glass cloth are coated with the thermally conductive silicone composition.

21. A method for producing a thermally conductive silicone, comprising:
adding a diluent to a thermally conductive silicone composition to prepare a coating liquid;
impregnating a glass cloth with the coating liquid, drying the glass cloth, and then heating and curing the glass cloth to prepare a sizing sheet; and
coating at least one surface of the sizing sheet of the glass cloth with the coating liquid, drying the sizing sheet, and then heating and curing the sizing sheet,
the thermally conductive silicone composition, which is a thermally conductive silicone cured product, comprising:
a silicone polymer as a matrix component; and
a thermally conductive filler,
wherein the matrix component includes a silicone base polymer (A) having a vinyl group, a silicone oil (B) having no vinyl group, and a silicone oil (C) having vinyl groups at both terminals,
the silicone base polymer (A) having a vinyl group is silicone gum,
if the matrix component is 100 parts by mass, the silicone base polymer (A) having a vinyl group is 44 to 71 parts by mass, the silicone oil (B) having no vinyl group is 11 to 45 parts by mass, and the silicone oil (C) having vinyl groups at both terminals is 11 to 45 parts by mass,
the thermally conductive filler includes aluminum nitride particles, and
the thermally conductive silicone composition includes a peroxide as a curing component.

22. The method according to claim 21, wherein the coating is performed by knife coating.

23. The thermally conductive silicone sheet according to claim 19, wherein the thermally conductive filler is 600 to 2000 parts by mass with respect to 100 parts by mass of the matrix component.

24. The thermally conductive silicone sheet according to claim 19, wherein if the thermally conductive filler is 100 parts by mass, the aluminum nitride particles are 10 to 100 parts by mass.

25. The thermally conductive silicone sheet according to claim 19, wherein the thermally conductive filler further includes alumina particles.

26. The thermally conductive silicone sheet according to claim 19, wherein an average particle size of the thermally conductive filler is 0.1 to 20 μm.

27. The method according to claim 21, wherein the thermally conductive filler is 600 to 2000 parts by mass with respect to 100 parts by mass of the matrix component.

28. The method according to claim 21, wherein if the thermally conductive filler is 100 parts by mass, the aluminum nitride particles are 10 to 100 parts by mass.

29. The method according to claim 21, wherein the thermally conductive filler further includes alumina particles.

30. The method according to claim 21, wherein an average particle size of the thermally conductive filler is 0.1 to 20 μm.
